(19) United States
(12) Patent Application Publication
(10) Pub. No.: US 2015/0243279 A1
(43) Pub. Date: Aug. 27, 2015

(54) SYSTEMS AND METHODS FOR RECOMMENDING RESPONSES

(71) Applicant: ToyTalk, Inc., San Francisco, CA (US)

(72) Inventors: Benjamin Morse, Berkeley, CA (US); Martin Reddy, San Francisco, CA (US); Aurelio Tinio, San Francisco, CA (US); James Chalfant, San Francisco, CA (US)

(21) Appl. No.: 14/632,187

(22) Filed: Feb. 26, 2015

Related U.S. Application Data
(60) Provisional application No. 61/944,969, filed on Feb. 26, 2014.

(51) Int. Cl. G10L 15/06; G06F 3/16; G06F 17/28; G06F 17/27

(52) U.S. Cl. CPC G10L 15/063; G06F 17/27; G06F 3/165; G06F 17/289; G10L 2015/0638

(57) ABSTRACT

Various of the disclosed embodiments concern systems and methods for identifying and recommending interesting user responses that are obtained by an interactive device (e.g., audio responses to a virtual character as part of a virtual interaction). In some embodiments, a user may interact with one or more virtual characters via a mobile device, tablet, desktop computer, or the like. During the interaction, the user may respond to one or more questions posed by the virtual characters or to contexts presented by the interactive device. The system may record these user responses, analyze the audio data to extract one or more features, and prepare a ranking of the user responses. The extracted features can be augmented with human-generated metadata or ground truth values. A reviewer can review, share, etc., the user response.

### CROSS-REFERENCE TO RELATED APPLICATION

This application claims the benefits of U.S. Provisional Patent Application Ser. No. 61/944,969, filed on Feb. 26, 2014. The subject matter thereof is incorporated herein by reference in its entirety.

### FIELD OF THE INVENTION

Various embodiments concern automated identification of user responses. More specifically, various embodiments relate to systems and methods for identifying and presenting interesting user responses collected during interactions with an animated character or situation.

### BACKGROUND

Educational or entertainment software exists that allows a user (e.g., child, student) to interact with a collection of animated characters or situations. Such software may be integrated into the existing social and telecommunications framework. In many instances, a reviewer (e.g., parent, teacher, mentor) may wish to monitor the user's progress or recent interaction(s) with the animated character or situation. Moreover, many reviewers wish to review the user responses in an efficient and timely manner. However, traditional systems do not permit efficient monitoring of user responses. Consequently, reviewers are left to review user responses that may be of little interest. As such, there are a number of challenges and inefficiencies found in traditional monitoring systems, particularly those related to artificial intelligence systems such as toys and games.

### SUMMARY

Systems and methods are described for identifying interesting responses from user responses collected during interactions with a synthetic character through an interactive device. In some embodiments, a method comprises receiving the user response, including an audio waveform, related to one or more user interactions with a synthetic character (e.g., supported by a toy or game). A textual hypothesis of the user response can be generated that includes a transcription of words present in the response. One or more features can also be extracted from the user response, the textual hypothesis, or both. In some embodiments, a metric value is determined for some or all of the extracted features. The extracted features can be weighted, normalized, or both based on the importance of the feature to interest level of the user response. In some embodiments, the metric values for all features in a single user response are summed, which results in a cumulative metric value. The cumulative metric value represents the interest level associated with a particular user response.

The systems described herein can include, or be connected to, a database or storage medium that includes the user responses, extracted features, metric values, and cumulative metric values. In some embodiments, the database includes one or more ground truth values provided by a reviewer. The ground truth values are provided to facilitate in the determination of whether a user response should be characterized as interesting. In some embodiments, supervised or unsupervised learning methods are applied to identify key features that are correlated with interesting user responses. The supervised or unsupervised learning methods can be configured to update the ground truth features accordingly.

Various embodiments of the present invention include a system having a processor, memory/database, recommendation engine, and a retrieval application program interface (API). In some embodiments, the recommendation engine receives one or more user responses from one or more interactive devices, extracts one or more features from each user response, generates a metric value for some or all of the extracted features, and determines a cumulative metric value for each user response. In some embodiments, the retrieval API receives a request for interesting user responses, identifies one or more interesting user responses, and transmits at least a portion of the one or more interesting user responses to an initiating device for review.

In some embodiments, a user interface is provided that permits a requester to submit a request for one or more interesting user responses, sends the request to a computing system, causes the system to identify at least one interesting user response, and presents the at least one interesting user response. The user interface can be configured to be presented by a web application or web-based portal, web browser, or a mobile application adapted for a cellular device, personal digital assistant (PDA), tablet, personal computer, etc.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIG. 1 is a generalized block diagram depicting certain components in a recommendation system as may occur in some embodiments.

FIG. 2 is a flow diagram depicting general steps in a recommendation process as may occur in some embodiments.

FIG. 3 is a flow diagram depicting aspects of the feature extraction and response ranking operations in greater detail as may be implemented in some embodiments.

FIG. 4 is a flow diagram depicting aspects of feature extraction and weight generation and/or assignment as may be implemented in some embodiments.

FIG. 5 is a flow diagram depicting aspects of preparing a response to a ranking request as may be implemented in some embodiments.

FIG. 6 is a screenshot of a response selection interface as may be presented in some embodiments.

FIG. 7 is a screenshot of a response selection interface with an active element as may be presented in some embodiments.

FIG. 8 is an enlarged screenshot of an active element in a response selection interface as may be implemented in some embodiments.

FIG. 9 is a block diagram illustrating an example of a computer system in which at least some operations described herein can be implemented according to various embodiments.

FIG. 10 is a block diagram with exemplary components of a system for recommending interesting user responses.

The figures depict various embodiments described throughout the Detailed Description for purposes of illustration only. While specific embodiments have been shown by way of example in the drawings and are described in detail below, the invention is amenable to various modifications and alternative forms. The intention, however, is not to limit the invention to the particular embodiments described. Accordingly, the claimed subject matter is intended to cover all modifications, equivalents, and alternatives falling within the scope of the invention as defined by the appended claims.

### DETAILED DESCRIPTION

Various embodiments are described herein that relate to identification of user responses. More specifically, various embodiments relate to automated systems and methods for identifying and recommending user responses that are determined to be “interesting.”

While, for convenience, various embodiments are described with reference to interactive synthetic characters for toys and games, embodiments of the present invention are equally applicable to various other artificial intelligence (AI) systems with business, military, educational, and/or other applications. The techniques introduced herein can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Topology Overview

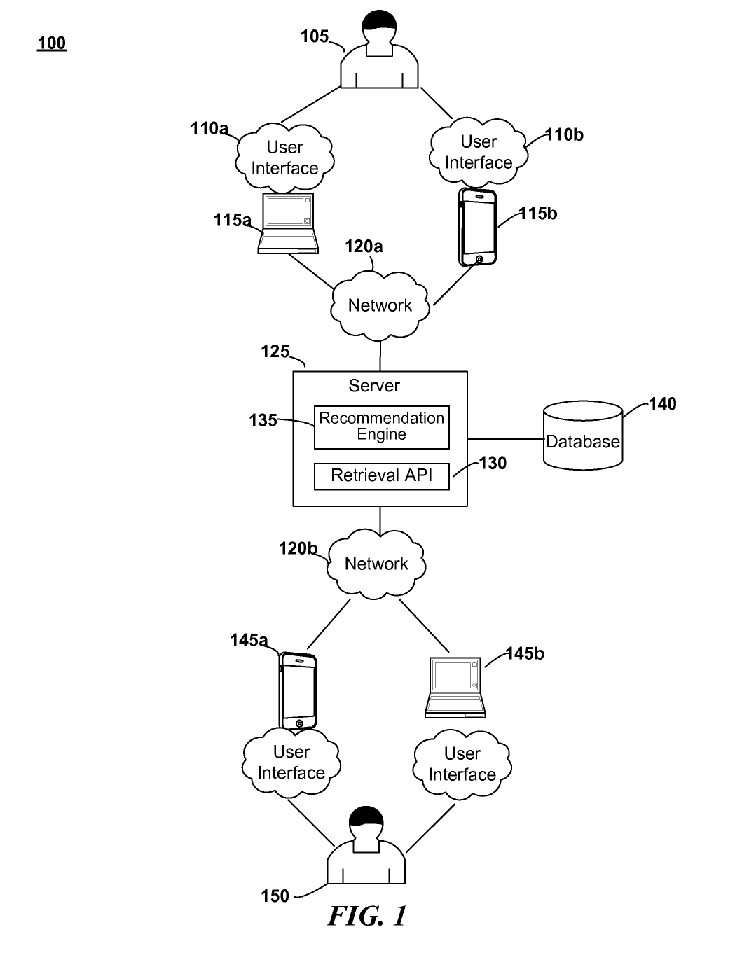

FIG. 1 is a generalized block diagram 100 depicting certain components in a recommendation system as may occur in some embodiments. A user 105, may engage with a virtual character (e.g., in a videogame, in learning software, etc.) on one or more interactive devices 115a-b. The interactive devices 115a-b may be, for example, a mobile phones, PDA, tablet (e.g., iPad®), personal computer, etc. Though, for purposes of illustration, the user is generally discussed herein as interacting with the virtual character through vocal responses, one skilled in the art will recognize that various embodiments contemplate alternative inputs (e.g., handwritten, symbol-based, or gesture-based responses by the user). For example, the user may interact with the virtual character by waving at or shaking the interactive device 115a-b. Interactive devices 115a-b may include a user interface 110a-b that can be configured to receive an audio input (e.g., via a microphone), a video input (e.g., via a webcam), or an image input (e.g., via a camera). In some embodiments, the user interface 110a-b is configured to project audio (e.g., via a speaker) or display the images and/or video (e.g., via a digital display). The interactive devices 115a-b may include an audio/video interface or connector. For example, interactive devices 115a-b may include a high-definition multimedia interface (HDMI) connector, an Institute of Electrical and Electronics Engineers (IEEE) standard 1394 connection, also called “Firewire,” etc.

In some embodiments, the one or more interactive devices 115a-b communicate with a server 125 over a network 120a (e.g., the Internet, a local area network, a wide area network, a point-to-point dial-up connection). The server 125 can include a recommendation engine 135 that is configured to receive user response data from interactive devices 115a-b and process the user responses. As described above, the recommendation engine 135 can be implemented using special-purpose hardware (e.g., circuitry), as programmable circuitry appropriately programmed with software and/or firmware, or as a combination of special-purpose and programmable circuitry. In some embodiments, the recommendation engine 135 stores metadata concerning the user responses and an interest ranking for each user response in a database 160. The interest ranking, also referred to as a uniqueness ranking or a novelty ranking, refers to how interesting a reviewer is likely to find the user response. The recommendation engine 135 or a speech recognition engine 140 can be configured to employ one or more speech recognition processes to determine what words are present in each user response.

A retrieval API 130 may be used to identify one or more interesting responses upon receiving a request. In some embodiments, the retrieval API 130 provides annotated and/or ranked user response data. The request can be initiated by a requester 150 and submitted via network 120b by one or more initiating devices 145 a-b. Network 120a and network 120b may be the same network or distinct networks. The requester 150 can be, for example, a teacher, parent, physician, psychologist, etc., who has an interest in reviewing and/or sharing interesting responses generated by the user 105 and obtained by the interactive devices 115a-b. In some embodiments, the retrieval API 130, recommendation engine 130, or both are configured to recommend a user response for review. The recommended response may be presented when the requester logs in to a web-based portal, accesses a particular web site, opens a mobile application, etc., on the initiating device 145a-b. Though reference may be made to an individual requester for purposes of explanation herein, one will recognize that the reviewer can be any individual, including, in some embodiments, the user who generated the user response.

### Recommendation Overview

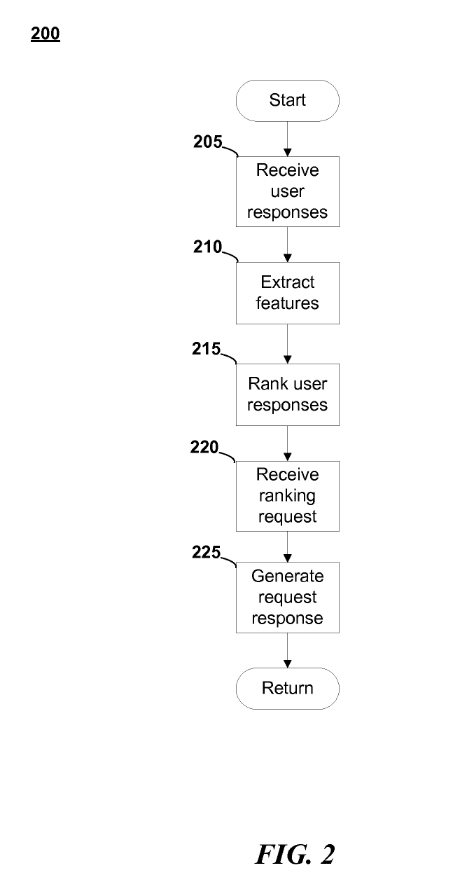

FIG. 2 is a flow diagram depicting general steps in a recommendation process 200 as may occur in some embodiments. At block 205, a recommendation engine may receive one or more user responses from one or more interactive devices (e.g., interactive devices 115a-b of FIG. 1). The user responses may be generated by a single user or a plurality of users. Patterns and trends may be identified by analyzing, processing, etc., user responses generated by a single user, or a particular group of users, over a period of time. For example, a requester (e.g., parent) may want to determine how a user's (e.g., child) responses have changed over time. A response may include an audio waveform, metadata concerning the context and time in which the user response was provided, an image or video of the user while generating the user response, etc. The metadata, which can include a time stamp, an indication of geographical location, a frequency count of user responses, etc., may collectively be referred to as contextual indications.

In some embodiments the recommendation engine may perform natural language processing upon the audio waveform to generate a textual hypothesis that may include a transcription of words present in the user response. The recommendation process 200 may occur entirely on the interactive device, entirely on a remote computing system, or be distributed across both (e.g., as part of a distributed computing system). At block 210, the recommendation engine can extract one or more features from the user response. Features may include user response duration, total word count, individual word count, fitted commonality score (e.g., a separate classifier output for how many common words are present), a flag indicating a tagged question, peak volume, average volume deviation, average duration deviation, average total word count deviation, a frequency representation of the audio waveform, etc. A tagged question may be, for example, a question categorized as a leading question, a question that could produce an interesting user response, or a question the requester has indicated is important or interesting.

At block 215, the recommendation engine can rank the user responses (e.g., by interest level). For example, the recommendation engine may assign metric values to each of the extracted features. The recommendation engine can also determine a cumulative metric for each user response by summing the metric values of all features present in each user response. The ranking may be a partial (e.g., subset of user responses) or total ordering of the user responses. The ranking of user responses may be ordered by cumulative metric value, such that interesting user responses are ranked higher. In some embodiments, the recommendation engine weights each metric value based on importance to interest level. For example, features that are more relevant to interest level may be weighted higher.

At block 220, the computing system (e.g., server) can receive a ranking request from an initiating device. For example, a web server configured to generate a web-based portal may allow parents to view progress made by a child on an interactive device. The web server may send a request to a response server that includes the recommendation engine. In some embodiments, the web server and the response server may be the same server. At block 225, the computing system can generate a response to the request. The response may include one or more interesting user responses, metadata statistics, user response summaries, etc. In various embodiments, the response can be delivered and presented to the requester. For example, the response may be sent as an email or presented by a web application or web-based portal, a web browser, a mobile application adapted for a cellular device, PDA, tablet, personal computer, etc.

### Feature Extraction and Ranking

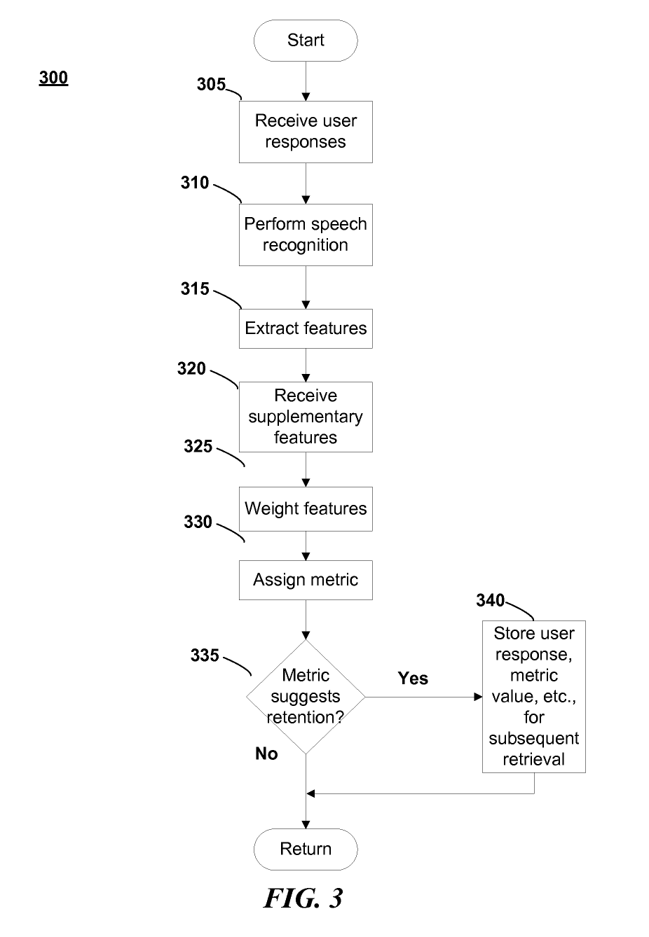

FIG. 3 is a flow diagram depicting aspects of the feature extraction and response ranking process 300 in greater detail as may be implemented in some embodiments. At block 305, the system may receive one or more user responses from an interactive device. The interactive device may be associated with one or more users. As described above, the user responses may comprise an audio waveform, an image (e.g., of the user), a video file, and/or metadata (e.g., contextual indications). In some embodiments the user responses are transmitted by the interactive device as it is recorded (i.e., in real-time). In some embodiments, one or more user responses are stored locally on the interactive device and sent to the computing system (e.g., server) in a batch for analysis. The processes and methods described herein can be performed locally on the interactive device, remote on a distinct computing system, or on a distributed computing system (e.g., some analysis is performed on the interactive device and some analysis is performed on one or more distinct computing systems). One skilled in the art will recognize that a variety of architectures can be employed that improve response time, processing power, storage, etc., without deviating from the purpose of the embodiments presented herein.

At block 310, the computing system can compute a textual hypothesis for the user response. The textual hypothesis may reflect the words understood to have been spoken by the user. For example, the textual hypothesis may include a textual transcription of the words present in the user response. In some embodiments, the textual hypothesis is computed automatically by a recommendation engine or a speech recognition engine (e.g., recommendation engine 135 and speech recognition engine 140 of FIG. 1).

At block 315, the system may extract features from the response. Features may include user response duration (“Length of Utterance”), total word count, individual word count (e.g., in a bag of words model), fitted commonality score, a flag indicating a tagged question, peak volume, average volume deviation, average duration deviation, average total word count deviation, a frequency representation of the audio waveform, etc.

In some embodiments, a ground truth feature value or feature set is provided to facilitate determination of interesting user responses. The ground truth feature value/set may be a “default” or “comparison” feature value/set that allows the computing system to determine interesting deviations. Features extracted from the user responses that resemble or differ from the ground truth feature set may be ranked higher or lower. In some embodiments, the ground truth feature value/set is configured to be updated. If the ground truth feature value/set is not up to date (e.g., a predetermined timer has expired since last update) an update process may be performed. For example, the update process may include additions, modifications, deletions, etc., to the ground truth feature value/set based on a global set of responses. The global set of responses can include all user responses from all users of the software, all feedback from all requesters, feedback concerning past responses of a particular user, etc. Bayesian prediction and various supervised or unsupervised learning methods may be applied to identify key features that are correlated with interesting user responses. The ground truth feature value/set can be updated accordingly. For example, a supervised machine learning system can determine an appropriate weighting of features based on an analysis of one or more ground truth values provided by one or more reviewers. As another example, an unsupervised machine learning system can determine an appropriate weighting of features based on an analysis of previous user responses.

At block 320, the computing system may optionally receive one or more additional or supplemental features provided by a requester, a separate system, etc. The supplemental features establish a ground truth for whether a user response should be classified as “interesting” (e.g., unique, novel) or “not interesting.” Whether a user response is “interesting” or “not interesting” may depend on the user (e.g., computing system is configured to consider linguistic or behavioral tendencies of the user) or the reviewer (e.g., computing system is configured to consider what user responses the reviewer has found interesting in the past). The supplemental features may also be based on the behavior of the reviewer, such as listening to the entirety of a user response, reviewing the user response multiple times, or taking actions that indicate the user response is interesting (e.g., choosing to share the user response with others, flagging the user response as a favorite). Accordingly, the supplemental features may optionally complement those features extracted from the user responses.

At block 325, the system may apply weights to the extracted features. For example, the duration of the user response in milliseconds may be normalized to a common score relative to utterances of other lengths. The normalized score can then be weighted based on the relevance of that feature to the interest level (e.g., uniqueness) of the user response. Some embodiments may weight extracted features based on a preference of a reviewer. The reviewer preference(s) can be applied during feature extraction or later on (e.g., when a request is submitted). For example, the computing system may store user profiles for more than one reviewer (e.g., parent, teacher). The user profiles can include metadata tags (e.g., keywords, duration, peak volume) that assist the system in determining what user responses each reviewer is likely to find interesting. The metadata tags can be input by each reviewer or generated by the computing system based on previous user responses analyzed by the reviewer and flagged as interesting. Once weighted normalized values have been determined for some or all of the extracted features, at block 330 the system can sum the weighted normalized values to determine a cumulative metric value for the entire user response. One skilled in the art will recognize the metric values associated with each extracted feature may be normalized, weighted, both normalized and weighted, or neither normalized nor weighted in various embodiments.

At block 335, the system can determine whether the cumulative metric value suggests retaining the user response (e.g., in a storage medium). Sensitivity to retaining user responses may vary across different embodiments. For example, user responses may be discarded unless the cumulative metric value suggests a high likelihood of being characterized as “interesting.” As another example, user responses may be retained if they cannot be trivially discarded from future processing. A user response might be trivially discarded if the audio waveform is empty, if the user spoke a single word, or if the user response was shorter than a predetermined threshold. If the metric suggests retention at block 340, the system can store (e.g., in database 160 of FIG. 1) the user response, the extracted feature(s), the metric value for each extracted feature, the cumulative metric value for the user response, and any relevant metadata for subsequent retrieval.

### Feature Extraction, Weight Generation, and Assignment

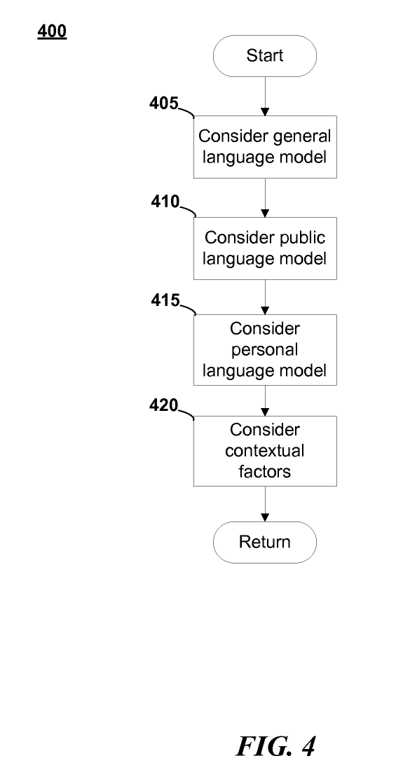

FIG. 4 is a flow diagram depicting aspects of process 400 for natural language processing (e.g., feature extraction and weight generation/assignment) as may be implemented in some embodiments. At block 405, the system can employ a general language model for information retrieval and identification. For example, the system may employ a bag-of-words model, in which the text of a user response is represented as a bag of its words (i.e., grammar and word order disregarded). The general language model may include a generic corpus of feature values that indicate how the user response should be analyzed (e.g., user language, user age, user activity when user response obtained).

At block 410, the system can employ a public language model. For example, the system may again employ a bag-of-words model, but the “bag” may include words identified in user responses associated with other (i.e., distinct) users. The public language model may include a corpus of feature values corresponding to other users. For example, the system may employ a pattern that has been identified in other users' responses and that correctly characterizes user responses as interesting.

At block 415, the system can consider a personal language model. Again, the system may employ a bag-of-words model, but the corpus of feature values may include one or more features, previously extracted from one or more user responses, that are unique with reference to all other user responses obtained from a particular user (e.g., for a related question or similar interaction) in the past.

At block 420, the system can consider additional contextual factors. For example, where the user is posed a question in a sad, morose context, the system may identify one or more characteristics or features associated with a jocular response, which may indicate an interesting (e.g., unique, unexpected) response by the user. The reference values supplied by each of blocks 405-420, may be considered and weighted with varying degrees of relevance to adjust the final result. For example, if the user response was provided immediately or shortly after an update to the system, there may be fewer public or personal user responses. Consequently, blocks 405 and 420 may be accorded greater influence in weighting the extracted features than blocks 410 and 415. One skilled in the art will recognize that, over time, it may be necessary to change, or even reverse, these weighting preferences. In some embodiments, the system is configured to automatically change the weighting preferences based on various factors (e.g., ratio of personal user responses to public user responses).

In some embodiments, it may be desirable for the system to err on the side of generating false negatives (e.g., user responses are characterized as “interesting,” but are ranked lowly and discarded). Presenting too many false positives to a reviewer may dull their expectation and make the reviewer less likely to take heed of a future user response characterized as “interesting,” even if the user response is truly unique. In some embodiments, it may be desirable for the system to err on the side of generating false positives (e.g., user responses are characterized as “interesting,” but are not in fact considered interesting by reviewer). The system may be able to modify its propensity for false positives/negatives automatically (e.g., by observing how the reviewer characterizes responses) or manually (e.g., reviewer may indicate whether one is preferred).

### Response Retrieval and Ranking Requests

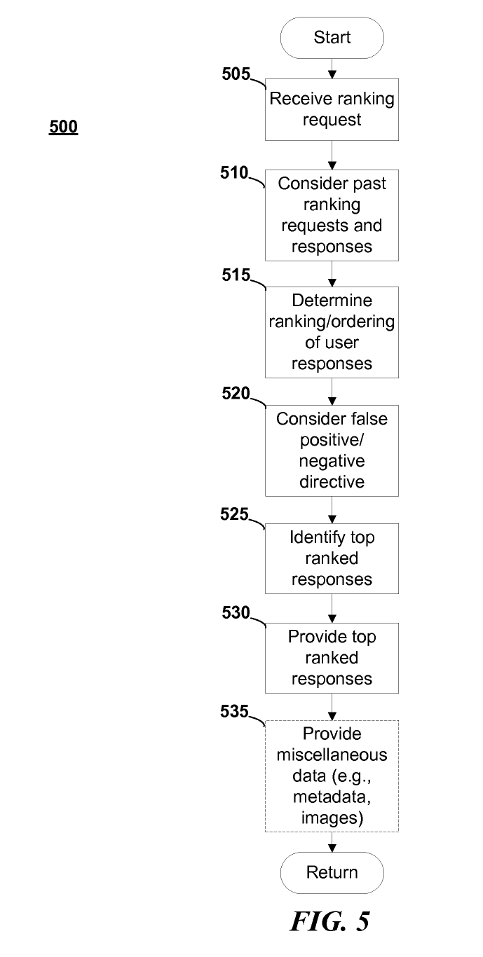

FIG. 5 is a flow diagram depicting aspects of a process 500 (e.g., via API) for preparing a response to a ranking request as may be implemented in some embodiments. For example, after the responses are analyzed and stored in a database (e.g., database 160 of FIG. 1), the system may receive a request at block 505 for a ranking of the most interesting (e.g., unique, relevant) responses. The request may specify one or more parameters upon which to base the assessment. For example, stored metrics may include metadata, rankings, etc., regarding concern, humor, spontaneity, deviation from the norm, keywords spoken by the user (e.g., “daddy”), etc. A request may specify that one or more of these features should take priority. A request may also specify that one or more of these features should be disregarded when determining interest level. In some embodiments, the request indicates a number of responses to return (e.g., top five, ten). In some embodiments, the process is implemented by an API. The API may be configured to search a database or storage medium that includes user responses, features, and metadata based on different cross-sections. For example, the API may search for the most interesting response among a particular group of users or the most interesting response among a collection of utterances by a single user. One skilled in the art will recognize that specific inquiries can be performed for particular questions, groups of users, etc. For example, a reviewer could request a response to “What do you want for Christmas?” from a subset of users (e.g., children within a particular age range or geographical location), seeking the most interesting user responses.

At block 510, the system can consider previous requests and previous user responses to identify one or more patterns in a requester's preferences and/or among user responses. For example, the system may determine that, among similarly ranked user responses, a user response having more features in common with previous selections made by the requester may be returned, despite having a smaller or lesser ranking.

At block 515, the system can determine a total or partial ranking of the stored user responses. For example, the system may generate a ranking for all stored user responses or a subset of user responses (e.g., by time, by question popularity). The ranking can be based on the cumulative metric value associated with each user response. In some embodiments, the ranks are generated such that high values correspond to interesting user responses. In some embodiments, the ranks are generated such that low values correspond to interesting user responses. In various embodiments, the system can also determine a total or partial ordering of the user responses. For example, a subset of ranked user responses can be ordered such that interesting user responses are ranked higher. As another example, the system may order the user responses into bands (e.g., very interesting, somewhat interesting, not at all interesting). The ranking and/or ordering employed by the system may be determined by the requester or based on the requester's preferences.

At block 520, the system may consider a false positive or false negative directive, as discussed above with respect to FIG. 4. For example, the system may impose a threshold requirement (e.g., duration, response topic) that prevents certain responses from being included in the response to a request. The threshold requirements may be imposed so that only the user responses a reviewer is most likely to find interesting are provided to the reviewer. In some embodiments, higher threshold requirements are implemented to ensure that, if any response is provided to the request, the response will include only those user responses very likely to be characterized as interesting. Whether a user response is “very likely” to be characterized as interesting may depend on past reviewer selections, response(s) by other reviewers to a particular user response, etc.

At block 525, the system can identify the top-ranked user response assets (e.g., the audio waveform, metadata). As described above, the user responses can be ranked by cumulative metric value, metric value for a particular feature, etc. For example, a review may request that the user responses be ranked only by humor, although this may result in the reviewer missing interesting responses in other categories (e.g., concern, fear, spontaneity). At block 530, the system can provide one or more of the user response assets in response to the request. In some embodiments, the system may also provide miscellaneous data associated with the response at block 535, such as metadata, images, or video of the user while generating the user response.

In some embodiments, a supervised machine learning process (e.g., support vector machines, decision trees, neural network) or an unsupervised machine learning process (e.g., clustering, neural network) may be used to predict interesting user responses. One skilled in the art will recognize that a number of supervised and unsupervised learning techniques could be employed by the systems and methods described herein. For example, various methods can be executed by a supervised machine learning system that determines an appropriate weighting of features based on a sufficiently large corpus of ground truth features provided by one or more reviewers (e.g., humans). As another example, various methods can be executed by an unsupervised machine learning system that determines an appropriate weighting of features based on an analysis of previous user responses. The machine learning systems and processes described herein may be used to empirically discover how best to combine various features in order to identify and recommend interesting user responses.

### Retrieval GUI

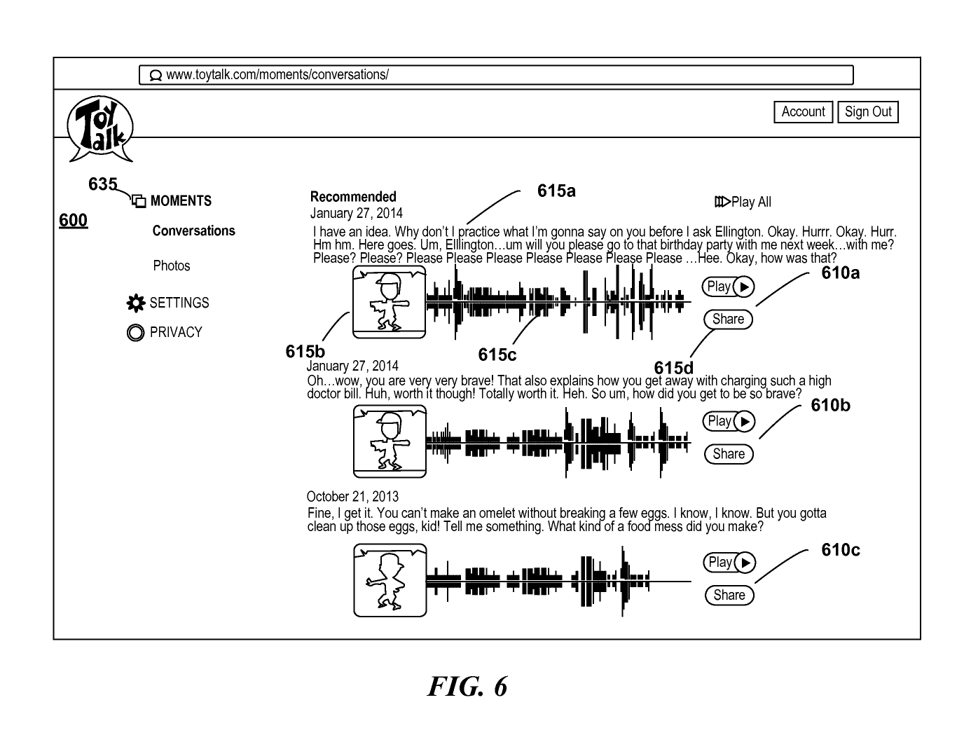

FIG. 6 is a screenshot 600 of a user response selection interface as may be presented in some embodiments. The user response(s) may be sent as an email or presented by a web application or web-based portal, a web browser, a mobile application adapted for a cellular device, PDA, tablet, personal computer, etc. One or more user responses can be presented. The user responses can be presented automatically upon logging in, delivered to a requester when a predetermined event occurs (e.g., end of the week, interesting response obtained), presented upon receiving a request from the reviewer, etc. For example, a plurality of user responses 610a-c are presented in FIG. 6, each user response 610a-c including an image of the user 615b, an audio waveform 615c of the user's response, and an indication 615a of the context in which the response as provided. In some embodiments, the reviewer is presented with the option to share 615d the response (e.g., via email, short message service (SMS), multimedia messaging service (MMS), social network). Settings and various parameters 635 can be provided that allow a reviewer customize the user interface, how the user responses are presented, or what user responses are presented. In various embodiments, the image of the user 615b may be an illustration and/or may include an overlay (e.g., of a costume relevant to the user's response). For example, the image 615b may include a pirate costume if the user was impersonating a pirate when the user response was recorded.

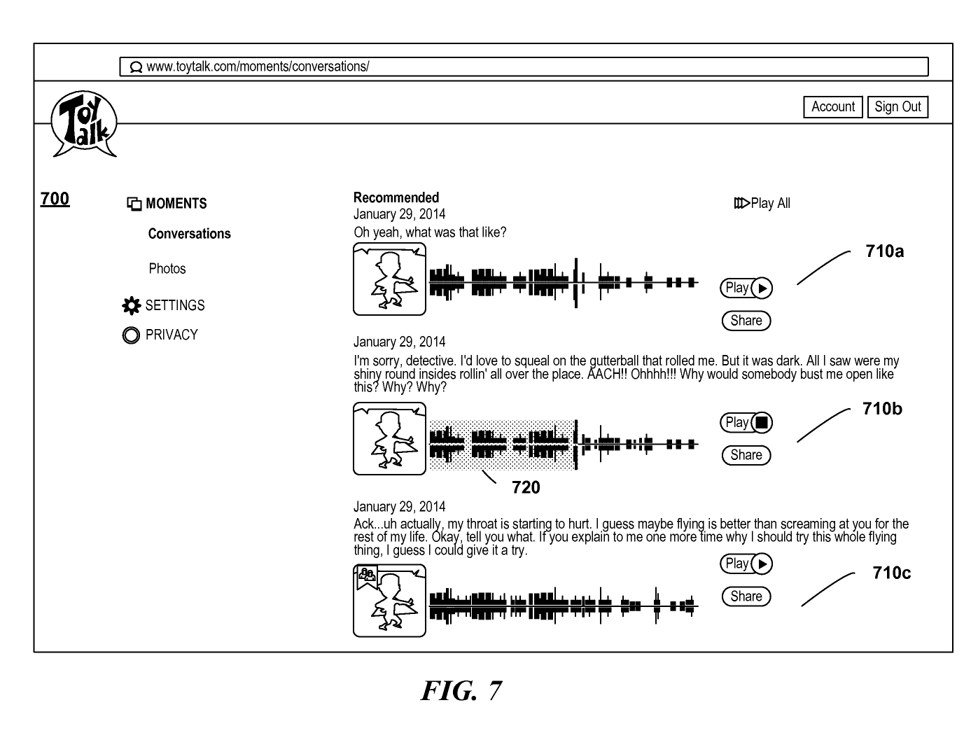

FIG. 7 is a screenshot 700 of a user response selection interface with an active element 710b chosen from among a plurality of elements 710a-c as may be presented in some embodiments. The reviewer can activate a particular user response (e.g., active element 710b) in various ways, including pressing the “Play” icon or “Share” icon, clicking the audio waveform or image of the user, etc. Color coding or other identifiers may be used to indicate a user response is active. For example, of the audio waveform 720 may change color as progress is made.

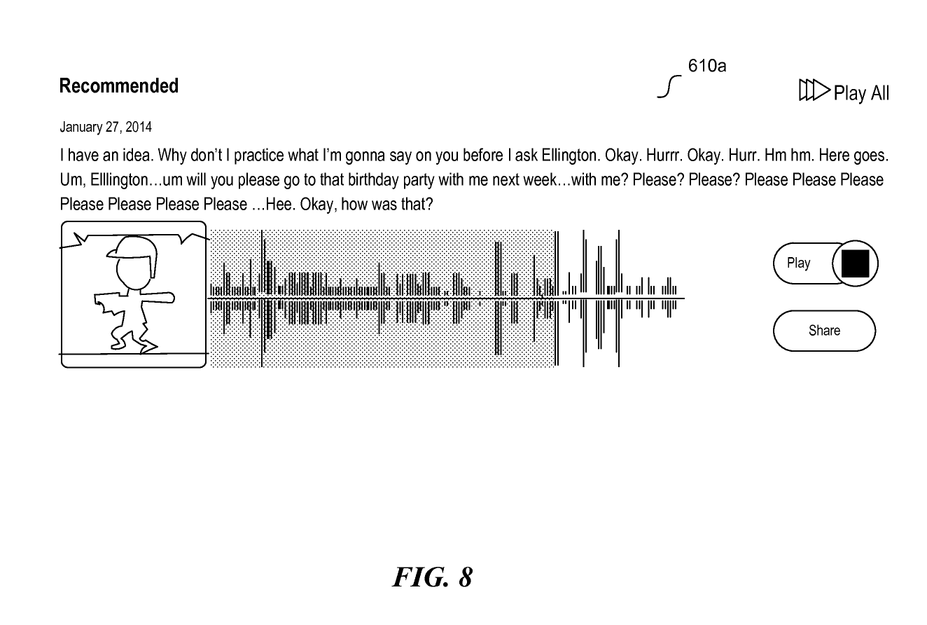

FIG. 8 is an enlarged screenshot of an active element 610a in a user response selection interface as may be implemented in some embodiments. In this example, the user response has been activated and the color of the audio waveform has been adjusted to illustrate that a portion of the audio waveform has been played.

### Computer System

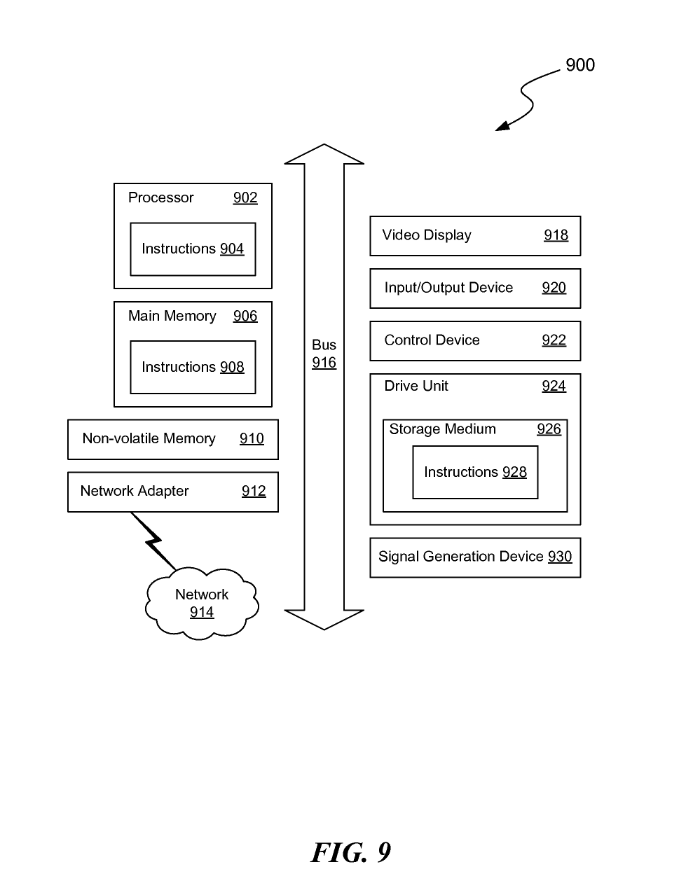

FIG. 9 is a block diagram illustrating an example of a computing system 900 in which at least some operations described herein can be implemented. The computing system may include one or more central processing units (“processors”) 902, main memory 906, non-volatile memory 910, network adapter 912 (e.g., network interfaces), video display 918, input/output devices 920, control device 922 (e.g., keyboard and pointing devices), drive unit 924 including a storage medium 926, and signal generation device 930 that are communicatively connected to a bus 916. The bus 916 is illustrated as an abstraction that represents any one or more separate physical buses, point to point connections, or both connected by appropriate bridges, adapters, or controllers. The bus 916, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 900 operates as a standalone device, although the computing system 900 may be connected (e.g., wired or wirelessly) to other machines. In a networked deployment, the computing system 900 may operate in the capacity of a server or a client machine in a client-server network environment, or as a peer machine in a peer-to-peer (or distributed) network environment.

The computing system 900 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 906, non-volatile memory 910, and storage medium 926 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 928. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 904, 908, 928) set at various times in various memory and storage devices in a computer, and that, when read and executed by one or more processing units or processors 902, cause the computing system 900 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 910, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 912 enables the computing system 900 to mediate data in a network 914 with an entity that is external to the computing device 900, through any known and/or convenient communications protocol supported by the computing system 900 and the external entity. The network adapter 912 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 912 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

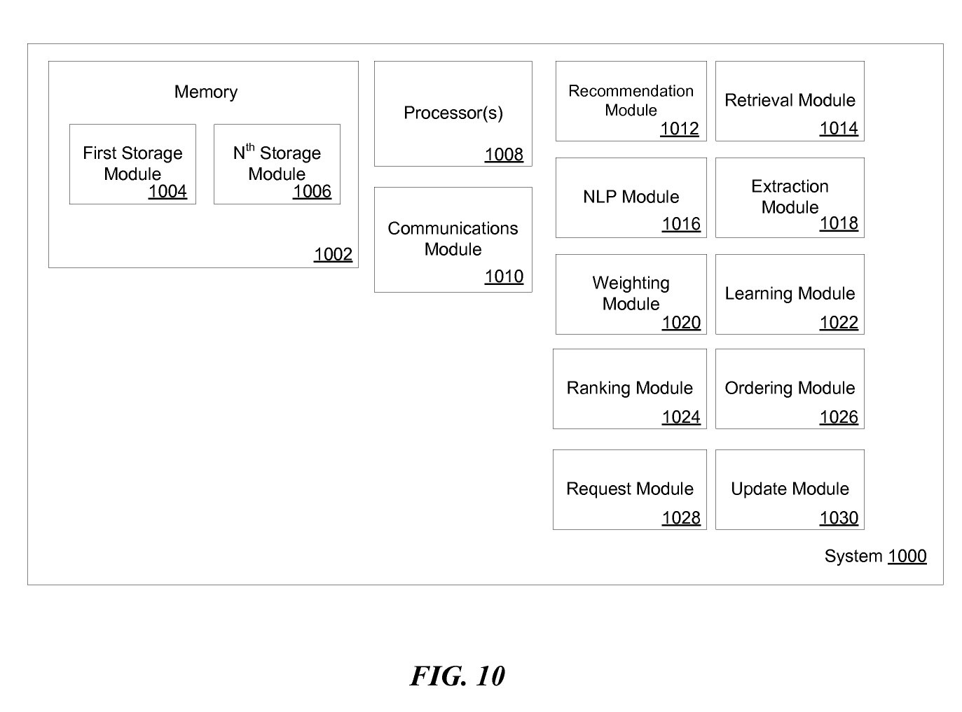

FIG. 10 is a block diagram with exemplary components of a system 1000 for recommending interesting user responses. According to the embodiment shown in FIG. 10, the system 1000 can include a memory 1002 that includes a first storage module 1004, second storage module, etc., through an N^{th} storage module 1006, one or more processors 1008, a communications module 1010, a recommendation module 1012, a retrieval module 1014, a natural language processing (NLP) module 1016, an extraction module 1018, a weighting module 1020, a learning (e.g., supervised or unsupervised machine learning) module 1022, a ranking module 1024, an ordering module 1026, a request module 1028, and an update module 1030. Other embodiments of the system 1000 may include some, all, or none of these modules and components along with other modules, applications, and/or components. Still yet, some embodiments may incorporate two or more of these modules into a single module and/or associate a portion of the functionality of one or more of these modules with a different module.

As described above, memory 1002 can be any device or mechanism used for storing information. Memory 1002 may be used to store instructions for running one or more applications or modules (e.g., recommendation module 1012, NLP module 1016) on processor(s) 1008. Communications module 1010 may manage communications between components and/or other systems. For example, the communications module 1010 may be used to receive information (e.g., user responses) from an interactive device, transmit information (e.g., ranked user responses, summaries) to an initiating device, etc. The information received by the communications module 1010 can be stored in the memory 1002, in one or more particular modules (e.g., module 1004, 1006), in a database communicatively coupled to the system 1000, or in a combination thereof.

A recommendation module 1012 can allow the system to receive one or more user responses and determine which responses, if any, should be characterized as “interesting.” The recommendation module 1012 may be configured to perform all or some of the steps and processes described above. In some embodiments, the recommendation module 1012 coordinates the actions of a plurality of modules (e.g., NLP module 1016, extraction module 1018) that together determine whether a user response should be characterized as interesting.

A retrieval module 1014 can process user responses transmitted by one or more interactive devices to the system and retrieve interesting user response(s) upon receiving a request from a reviewer. In some embodiments, the retrieval module is able to process metadata associated with the user response and categorize the user response based on duration, user, peak volume, etc. A NLP module 1016 can employ one or more speech recognition processes to determine what words are present in each user response. In various embodiments, the NLP module 1016 generates a textual hypothesis of an audio waveform associated with the user response. The textual hypothesis can include a transcription of words the NLP module 1016 has determined are present in the audio waveform.

An extraction module 1018 can extract one or more features from the user response. Features may include user response duration, total word count, individual word count, fitted commonality score, a flag indicating a tagged question, peak volume, average volume deviation, average duration deviation, average total word count deviation, a frequency representation of the audio waveform, etc. The extraction module 1018, recommendation module 1012, etc., may also assign metric values to each of the extracted features. A weighting module 1020 can weight each metric value based on importance to interest level. For example, features that are more relevant to interest level may be weighted higher.

A learning module 1022 can add, modify, delete, etc., features from a ground truth feature value/set based on a set of user responses. The set of responses can include all user responses from all users of the software, all feedback from all requesters, feedback concerning past responses of a particular user, etc. Bayesian prediction and various supervised or unsupervised learning methods may be applied to identify key features that are correlated with interesting user responses. The supervised or unsupervised learning methods can be employed to ensure greater success in recommending user responses that are truly interesting.

A ranking module 1024 can store metadata concerning the user responses, generate an interest ranking based on the metadata and any extracted features, and store the ranking for each user response in a memory (e.g., memory 1002) or storage. The interest ranking, also referred to as a uniqueness ranking or a novelty ranking, refers to how interesting a reviewer is likely to find the user response. An ordering module 1026 can generate a partial or complete ordering of the user responses (e.g., within memory 1002). The user responses may be ordered by cumulative metric value, such that interesting user responses are ranked higher. The user responses may also be ordered by metric value for one or more particular features or type(s) of feature (e.g., peak volume or comedic responses only).

A request module 1028 can generate a graphical user interface (GUI) that allows a reviewer to submit a request (e.g., via a network), view user responses, etc. The request module 1028 may be configured to generate one or more GUIs for one or more initiating devices. For example, the request module 1028 may generate the same or different GUIs for a web-based portal, a web browser, a mobile application, etc. In some embodiments, the request module 1028 processes the request to identify whether the request is associated with a particular requester, a particular user, or whether any preferences (e.g., only comedic user responses) have been entered. An update module 1030 can update the ground truth feature value/set, user/requester preferences stored in memory 1002, etc. For example, if the update module 1030 determines the ground truth feature set is not up to date (e.g., a predetermined timer has expired since last update), the update module 1030 may modify (e.g., add or delete entries) the ground truth feature set based on recently received user responses.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A computer-implemented method for recommending interesting user responses produced by a user and obtained by an interactive device comprising:
receiving, from the interactive device, a user response including an audio waveform;
computing a textual hypothesis of the audio waveform, the textual hypothesis including a transcription of words identified in the audio waveform;
extracting a feature from the audio waveform, the textual hypothesis, or both;
generating a metric value for the feature, the metric value representing interest level of the feature;
weighting the metric value based on:
a general language model that includes a generic corpus of ground truth feature values that indicate how user responses should be analyzed;
a public language model that includes a public corpus of ground truth feature values derived from user responses produced by other users;
a personal language model that includes a personal corpus of ground truth feature values derived from user responses previously produced by the user; and
contextual factors that indicate whether the user response should be characterized as interesting; and
summing the weighted metric value with all other weighted metric values associated with features extracted from the user response, thereby generating a cumulative metric value that represents interest level of the user response as a whole.

2. The computer-implemented method of claim 1, wherein the generic corpus of ground truth feature values, the public corpus of ground truth feature values, the personal corpus of ground truth feature values, and the contextual factors are weighted with varying degrees of relevance.

3. The computer-implemented method of claim 1, wherein the user response is obtained by the interactive device when the user interacts with a virtual character via a user interface.

4. The computer-implemented method of claim 1, wherein the feature includes a determination of user response duration, total word count, individual word count, a fitted commonality score, a flag indicating a tagged question, a peak volume, average volume deviation, average duration deviation, average total word count deviation, or any combination thereof.

5. The computer-implemented method of claim 1, further comprising:
generating at least one supplemental feature derived from a behavior of a reviewer, the behavior including examining the entirety of the user response, reviewing the user response multiple times, electing to share the user response, or any combination thereof.

6. The computer-implemented method of claim 1, wherein generating the cumulative metric value for the user response includes evaluating a stored feature of a previous user response.

7. The computer-implemented method of claim 6, wherein the previous user response is associated with the user or a distinct user.

8. The computer-implemented method of claim 1, wherein the method is executed by a supervised machine learning system that determines an appropriate weighting of the feature, the appropriate weighting based on an analysis of a corpus of ground truth values provided by a plurality of reviewers.

9. The computer-implemented method of claim 1, wherein the method is executed by an unsupervised machine learning system that determines an appropriate weighting of the feature, the appropriate weighting based on an analysis of previous user responses obtained from the user.

10. A system for identifying and recommending interesting user responses comprising:
a recommendation engine configured to:
receive a plurality of user responses obtained by one or more interactive devices, the plurality of user responses associated with a user;
extract a feature from each user response;
assign a metric value to each extracted feature, the metric value representing interest level of the feature; and
determine a cumulative metric value for each user response, wherein the cumulative metric value is determined by summing the metric values of all extracted features identified in each user response;
a retrieval application program interface configured to:
receive, from an initiating device, a request for interesting user responses;
identify an interesting user response from the plurality of user responses, the interesting user response identified based on cumulative metric value; and
transmit at least a portion of the interesting user response to the initiating device; and
a database configured to store the plurality of user responses, the extracted features, the metric value for each extracted feature, the cumulative metric value for each user response, or any combination thereof.

11. The system of claim 10, wherein the recommendation engine is further configured to:
normalize the metric value to a common score; and
weight the metric value based on importance of the feature to interest level of the user response.

12. The system of claim 11, wherein the metric value is weighted based on one or more of:
a general language model that includes a generic corpus of ground truth feature values that indicate how user responses should be analyzed;
a public language model that includes a public corpus of ground truth feature values derived from user responses produced by other users;
a personal language model that includes a personal corpus of ground truth feature values derived from user responses previously produced by the user; and
contextual factors that indicate whether the user response should be characterized as interesting.

13. The system of claim 10, wherein the retrieval application program interface is further configured to:
implement a false positive directive that errs on the side of characterizing more user responses as interesting; or
implement a false negative directive that errs on the side of characterizing fewer user responses as interesting.

14. The system of claim 10, wherein the recommendation engine is further configured to:
perform natural language processing on, and generate a textual hypothesis for, each user response, the textual hypothesis including a transcription of words identified in each user response.

15. The system of claim 11, wherein the recommendation engine is further configured to:
order the plurality of user responses by cumulative metric value, such that interesting user responses are ranked higher.

16. The system of claim 10, wherein the retrieval application program interface is further configured to:
identify a top “N” set of interesting user responses, wherein “N” is a predetermined integer; and
transmit the top “N” set to the initiating device associated with a requester.

17. The system of claim 16, wherein the top “N” set is ordered by cumulative metric value.

18. The system of claim 16, wherein the predetermined integer is determined by the requester.

19. The system of claim 10, wherein the initiating device is one of the one or more interactive devices.

20. The system of claim 19, wherein the recommendation engine, the retrieval application program interface, the database, or any combination thereof are stored on each of the one or more interactive devices.

21. The system of claim 10, wherein the recommendation engine, the retrieval application program interface, the database, or any combination thereof are stored on a remote storage medium communicatively coupled to each of the one or more interactive devices and the initiating device.

22. A user interface configured to:
permit a requester to specify a search parameter indicating desired characteristics of user responses to be retrieved;
send, to a processor, a request for interesting user responses, wherein the request includes the search parameter;
cause the processor to identify an interesting user response from a plurality of user responses stored in a storage medium, wherein each of the plurality of user responses includes an image of a speaker, an audio waveform, and a contextual indication;
receive, from the processor, the interesting user response; and
present the interesting user responses to the requester, wherein the user interface comprises a playback mechanism for reviewing the interesting user response.

23. The user interface of claim 22, wherein the processor identifies the interesting user response by:
computing, for each of the plurality of user responses, a textual hypothesis of the audio waveform, wherein the textual hypothesis includes a transcription of words identified in the audio waveform;
extracting a feature from the audio waveform, the textual hypothesis, or both;
determining a metric value for the feature, the metric value representing interest level of the feature;
weighting the metric value based on importance of the feature to interest level of the user response; and
summing the weighted metric value with all other weighted metric values associated with features extracted from the user response, thereby generating a cumulative metric value that represents interest level of the user response as a whole.

24. The request interface of claim 23, wherein the metric value is weighted based on one or more of:
a general language model that includes a generic corpus of ground truth feature values that indicate how user responses should be analyzed;
a public language model that includes a public corpus of ground truth feature values derived from user responses produced by other users;
a personal language model that includes a personal corpus of ground truth feature values derived from user responses previously produced by the user; and
contextual factors that indicate whether the user response should be characterized as interesting.

25. The request interface of claim 22, wherein the user interface is presented to the requester via an email, a web application, a web browser, or a mobile application adapted for one or more of a cellular device, a personal digital assistant, a tablet, and a personal computer.
